(19) United States
(12) Patent Application Publication
(10) Pub. No.: US 2018/0024691 A1
(43) Pub. Date: Jan. 25, 2018

(54) INPUT DEVICE INCLUDING A PLURALITY OF SENSORS

(71) Applicant: SENTOUS CO., Ltd., Seoul (KR)

(72) Inventor: Young-Jae MIN, Hwaseong-si (KR)

(73) Assignee: SENTOUS CO., Ltd., Seoul (KR)

(21) Appl. No.: 15/273,741

(22) Filed: Sep. 23, 2016

(30) Foreign Application Priority Data
Jul. 22, 2016 (KR) 10-2016-0093080

(51) Int. Cl. G06F 3/041; G06F 3/043

(52) U.S. Cl. CPC G06F 3/0418; G06F 3/043

(57) ABSTRACT

The input device according to an embodiment of the inventive concept may include a first sensor, a second sensor, or a sensor controller. The first sensor may receive a first acoustic signal generated by an acoustic signal generator. The second sensor may receive an abnormal signal different from the first acoustic signal. The sensor controller may receive a first sensing result from the first sensor and a second sensing result from the second sensor and output the sensing results to the electronic equipment. The first acoustic signal may be received by the first sensor through a housing that covers at least a portion of the electronic equipment. The input device according to an embodiment of the inventive concept may sense the acoustic signal and a signal different therefrom, sense whether the electronic equipment is in an abnormal state, and filter the acoustic signal.

### CROSS-REFERENCE TO RELATED APPLICATIONS

This U.S. non-provisional patent application claims priority under 35 U.S.C. §119 of Korean Patent Application No. 10-2016-0093080, filed on Jul. 22, 2016, the disclosure of which is hereby incorporated by reference in its entirety.

### BACKGROUND

The present disclosure herein relates to an input device, and more particularly, to an input device including a plurality of sensors.

In order to manipulate the function of electronic equipment, input devices, such as a key, button, mouse, and touch screen have been mostly developed. In general, the touch screen may be attached to the front surface of the electronic equipment. The touch screen may deliver user touch information to the inside of the electronic equipment.

In recent, with a development in the function of the electronic equipment, the input unit of the electronic equipment is also being developed. In addition to the disposition of an input device on the front surface of the electronic equipment, the input device may also be disposed on the rear or side surface thereof. However, as the input device is disposed on the front, rear, and side surfaces of the electronic equipment, there is a problem in that the electronic equipment receives unnecessary information.

### SUMMARY

The present disclosure provides an input device that includes a plurality of sensors.

The input device according to an embodiment of the inventive concept may include a first sensor, a second sensor, or a sensor controller. The first sensor may receive a first acoustic signal generated by an acoustic signal generator. The second sensor may receive an abnormal signal different from the first acoustic signal. The sensor controller may receive a first sensing result from the first sensor and a second sensing result from the second sensor and output the sensing results to the electronic equipment. The first acoustic signal may be received by the first sensor through a housing that covers at least a portion of the electronic equipment.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a diagram that illustrates electronic equipment to which an input device according to an embodiment of the inventive concept is applied;

FIG. 2 is a block diagram that illustrates an input device according to an embodiment of the inventive concept;

FIGS. 3 and 4 are diagrams that illustrate the rear surface of electronic equipment to which an input device according to an embodiment of the inventive concept is applied;

FIG. 5 is a block diagram that illustrates an input device according to an embodiment of the inventive concept;

FIG. 6 is a block diagram that illustrates electronic equipment to which an input device according to an embodiment of the inventive concept is applied;

FIG. 7 is a diagram that illustrates electronic equipment to which an input device according to an embodiment of the inventive concept is applied; and

FIG. 8 is a block diagram that illustrates a computer system to which an input device according to an embodiment of the inventive concept is applied.

### DETAILED DESCRIPTION

In the following, embodiments of the inventive concept are described clearly and in detail so that a person skilled in the art to which the inventive concept pertains may easily practice the inventive concept.

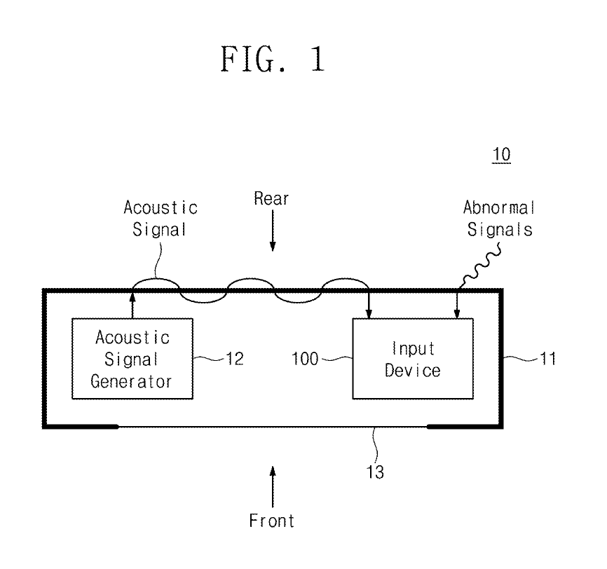

FIG. 1 is a diagram that illustrates electronic equipment to which an input device according to an embodiment of the inventive concept is applied. Here, the electronic equipment may be a mobile device, such as a smart phone, tablet, smart watch, personal digital assistant (PDA), wearable device, or digital camera. The electronic equipment may be a smart TV, printer, scanner, or computer, in addition to the mobile device. Referring to FIG. 1, electronic equipment 10 may include a housing 11, an acoustic signal generator 12, a display 13, and an input device 100.

The housing 11 may be disposed along the edge of the electronic equipment 10. Referring to FIG. 1, the housing 11 may be disposed along a portion (thick line in FIG. 1) of the edge of the electronic equipment 10, not a whole of the edge thereof. As an example, in FIG. 1, the housing 11 may cover only a portion of the front surface of the electronic equipment 10 when viewing the electronic equipment 10 from the front. In this case, the display 13 to be described below may be disposed at a portion on which the housing 11 is not covered. When viewing the electronic equipment 10 from the rear, the housing 11 may cover a whole of the rear surface of the electronic equipment 10.

The housing 11 may be made of various materials in order to protect the electronic equipment 10. The housing 11 may cover at least a portion of the electronic equipment 10. For example, the housing 11 may be metal, glass, plastic, or a synthetic resin, etc. The internal components (not shown) of the electronic equipment 10 may be protected from an external impact by the housing 11.

The acoustic signal generator 12 may generate an acoustic signal. The generated acoustic signal may be transmitted to any part of the electronic equipment 10 along the housing 11. More particularly, the acoustic signal may be transmitted along the rear surface of the electronic equipment 10. To this end, the housing 11 may be made of a material which the acoustic signal may be transferred. In order to effectively transfer the acoustic signal, the acoustic signal generator 12 may also be attached to the housing 11 through an insulator (not shown). In the case where a user touches the housing 11 with his or her finger, the acoustic signal transmitted along the housing 11 may be changed. For example, the frequency, amplitude, phase or arrival position of the acoustic signal may be changed. Since the acoustic signal is changed by a user's control, user control information may be included in the changed acoustic signal. The frequency of the acoustic signal may be a frequency beyond an audible field. That is, the acoustic signal may be an ultrasonic wave. For example, the frequency of the acoustic signal may be about 20 kHz or higher (e.g., about 100 kHz).

An interface between the user and the electronic equipment 10 may be displayed on the display 13. To this end, a whole of the edge of the electronic equipment 10 is not surrounded by the housing 11 but the display 13 may be disposed at a portion of the edge of the electronic equipment 10. Referring to FIG. 1, the display 13 may be disposed on the front surface of the electronic equipment 10. The display 13 may function as an interface between the user and the electronic equipment 10. The display 13 may include a liquid crystal display (LCD), organic light emitting diode (OLED), active matrix OLED (AMOLED), or light emitting diode (LED).

The input device 100 may be disposed inside the electronic equipment 10. More particularly, the input device 100 may be protected by the housing 11. The input device 100 may receive the acoustic signal generated by the acoustic signal generator 12. To this end, the input device 100 may be attached to the housing 11 through an insulator (not shown). However, the position of the input device 100 is not limited to that shown in FIG. 1. The input device 100 may be attached to the rear or side surface of the electronic equipment 10.

The input device 100 according to an embodiment of the inventive concept may receive the acoustic signal. The input device 100 according to an embodiment of the inventive concept may also receive other signals simultaneously in addition to the acoustic signal as described above. Here, other signals may mean abnormal signals that are input to the electronic equipment 10. For example, the abnormal signals may be vibration signals generated while the electronic equipment 10 falls, or acoustic signals. Alternatively, the abnormal signals may be vibration signals or acoustic signals generated while an impact is applied to the electronic equipment 10. That is, the abnormal signals may mean signals generated when the electronic equipment 10 is in an abnormal state.

The electronic equipment 10 may receive both the acoustic signal and the abnormal signals through the input device 100. The electronic equipment 10 may identify the acoustic signal and the abnormal signals through the input device 100. Accordingly, the electronic equipment 10 may filter the abnormal signals. The electronic equipment 10 may determine the acoustic signal and recognize user control information. More particularly, the electronic equipment 10 may determine the acoustic signal as noise and filter it when receiving the abnormal signals.

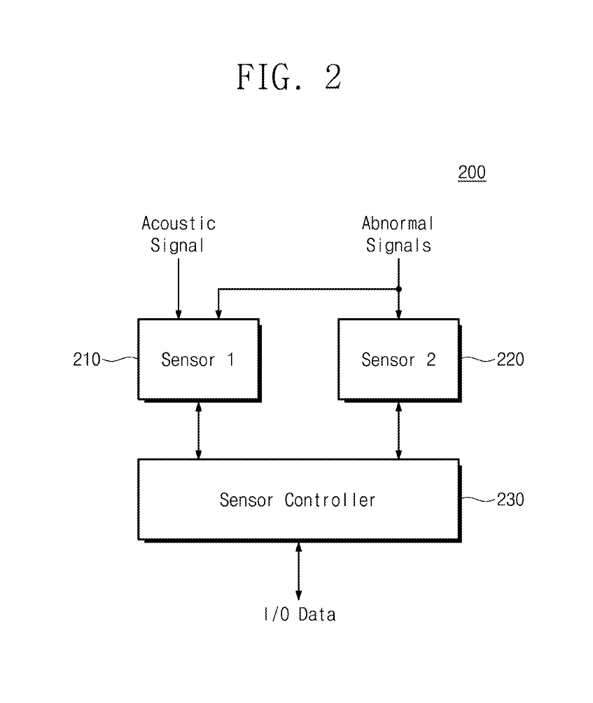

FIG. 2 is a block diagram that illustrates an input device according to an embodiment of the inventive concept. FIG. 2 is described with reference to FIG. 1. Referring to FIG. 2, an input device 200 may include a first sensor 210, a second sensor 220, and a sensor controller 230.

The first sensor 210 may receive the acoustic signal. As described above, the acoustic signal may be transmitted through the housing 11 (see FIG. 1). For example, the first sensor may be an acoustic sensor. The first sensor 210 may output the received acoustic signal to the sensor controller 230. The first sensor 210 may receive power from the sensor controller 230. As an example, the first sensor 210 may receive an ultrasonic wave. The first sensor 210 may receive a frequency of about 20 kHz or more.

The second sensor 220 may receive the abnormal signals. As described above, the abnormal signals may be generated irrespective of a user's control. The second sensor 220 may output the received abnormal signals to the sensor controller 230. The second sensor 220 may receive power from the sensor controller 230.

The second sensor may be a pressure sensor, a proximity sensor, a gyro sensor, an acceleration sensor, a magnetic sensor, a temperature sensor, a terrestrial magnetism sensor, etc.

For example, the second sensor 220 may be a pressure sensor. When a impact is applied to the electronic equipment 10 (see FIG. 1) due to a fall, the second sensor 220 may sense the impact. In particular, the electronic equipment 10 (see FIG. 1) may sense or receive an abnormal operation (fall) through the second sensor 220. In this case, the electronic equipment 10 (see FIG. 1) may filter the received acoustic signal through the first sensor 210.

Additionally, the first sensor 210 may further receive abnormal signals. In this case, the first sensor 210 may further sense the abnormal signals as well as the acoustic signal. The first sensor 210 may output the received acoustic signal or abnormal signals to the sensor controller 230.

The input device 200 may further include additional sensors in addition to the second sensor 220, though not shown. The additional sensors may receive the abnormal signals like the second sensor 220. The more the sensors, the input device 200 may more easily sense whether the electronic equipment 10 (see FIG. 1) is in an abnormal state.

The sensor controller 230 may receive a first sensing result from the first sensor 210. The sensor controller 230 may receive a second sensing result from the second sensor 220. The sensor controller 230 may supply power to the first sensor 210 and the second sensor 220.

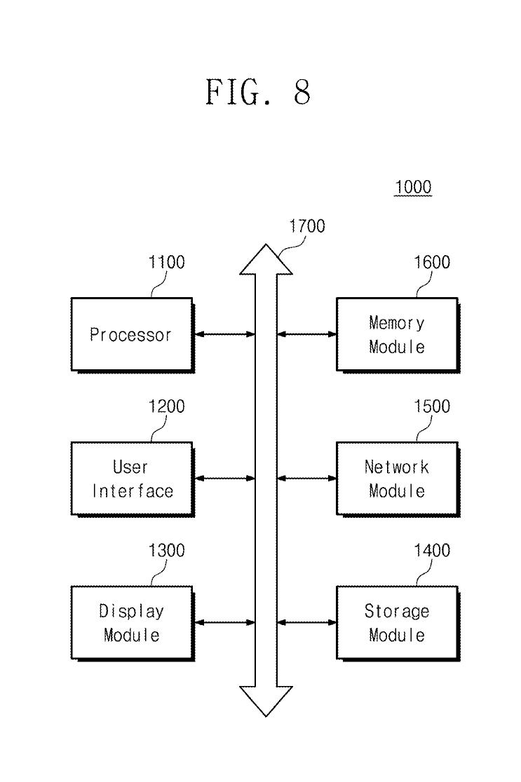

The sensor controller 230 may output (output data) the first sensing result and the second sensing result that have been received, to the electronic equipment 10 (see FIG. 1). More particularly, the sensor controller 230 may output the first sensing result and the second sensing result that have been received, to a processor (see FIG. 8 below). To this end, the sensor controller 230 may include an analog to digital converter (ADC) (not shown). The first sensing result and the second sensing result may be analog signals. The ADC may digitalize the first sensing result and the second sensing result. After being digitalized, the first sensing result and the second sensing result may be output to the electronic equipment 10 (see FIG. 1).

The sensor controller 230 may control the first sensor 210 and the second sensor 220 with reference to the control (input data) of the electronic equipment 10 (see FIG. 1). For example, in the case where the electronic equipment 10 (see FIG. 1) operates in a low-power mode, the sensor controller 230 may turn off the first sensor 210 and the second sensor 220 with reference to the control of the electronic equipment 10 (see FIG. 1).

The input device 200 according to an embodiment of the present invention may be manufactured in the form of a system in package (SiP) or system on chip (SoC). Manufacturing the input device 200 in the form of the SiP or SoC provides the input device 200 with an advantage in attaching it to any position of the electronic equipment 10 (see FIG. 1). For example, the input device 200 may be disposed at the rear or side surface of the electronic equipment 10 (see FIG. 1). More particularly, the position of the input device 200 may be set with reference to the position of the acoustic signal generator 12 (see FIG. 1) or a user's touch region.

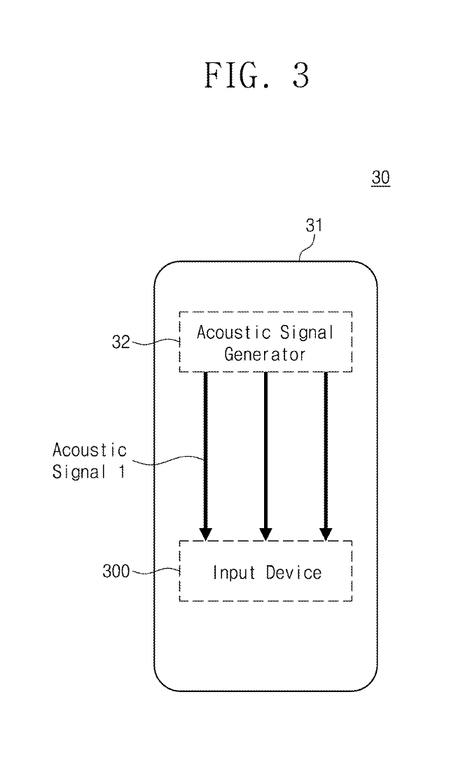

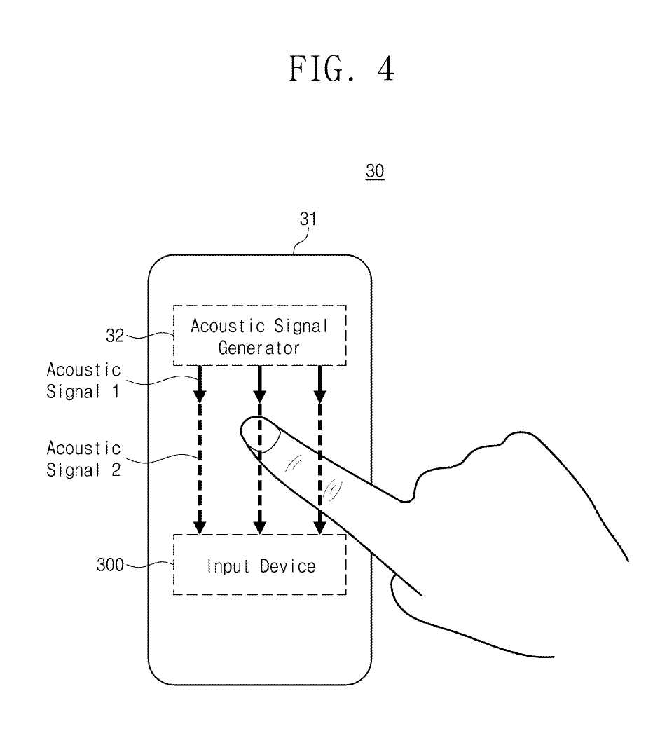

FIGS. 3 and 4 are diagrams that illustrate the rear surface of electronic equipment to which an input device according to an embodiment of the inventive concept is applied. Referring to FIGS. 3 and 4, electronic equipment 30 may include an acoustic signal generator 32 and an input device 300 in a housing 31. FIG. 3 relates to the case where a touch is not performed on the electronic equipment 30. FIG. 4 relates to the case where a touch is performed on the electronic equipment 30.

Referring to FIG. 3, the acoustic signal generator 32 may generate a first acoustic signal. The first acoustic signal may be transmitted to the input device 300 through the housing 31. At this point, since the touch is not performed on the electronic equipment 30, the electronic equipment 30 may recognize that there is no input from a user through the input device 300.

Referring to FIG. 4, the acoustic signal generator 32 may generate the first acoustic signal in common with the case in FIG. 3. The first acoustic signal may be transmitted to the input device 300 through the housing 31. At this point, the user may perform a touch on the electronic equipment 30. Due to the touch, the first acoustic signal may be changed to a second acoustic signal. More particularly, the second acoustic signal may mean a signal that the first acoustic signal has changed in frequency, amplitude, phase, etc.

Unlike FIG. 3, the input device 300 in FIG. 4 may further receive the second acoustic signal instead of the first acoustic signal. The electronic equipment 30 may recognize the touch operation of the user through the input device 300. More particularly, the electronic equipment 30 may analyze the difference between the first acoustic signal and the second acoustic signal that have been received through the input device 300 and recognize the touch operation of the user. That is, the user may touch the electronic equipment 30 to which the input device 300 according to an embodiment of the present invention is applied, to control the sound or screen of the electronic equipment 30.

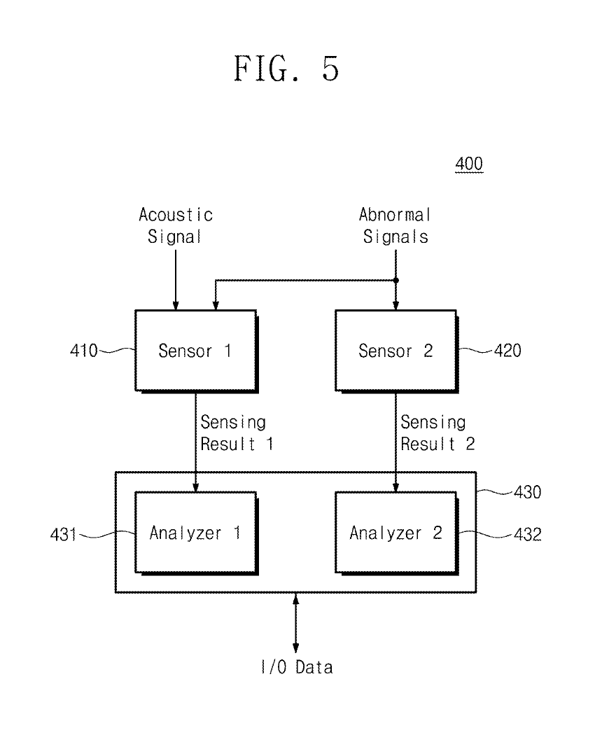

FIG. 5 is a block diagram that illustrates an input device according to an embodiment of the inventive concept. Referring to FIG. 5, an input device 400 may include a first sensor 410, a second sensor 420, and a sensor controller 430. The first sensor 410 and the second sensor 420 are substantially the same as those in FIG. 2.

In FIG. 2, the sensor controller 230 (see FIG. 2) may transmit the first sensing result and the second sensing result to the electronic equipment 10 (see FIG. 1). In contrast, the sensor controller 430 in FIG. 5 may process the first sensing result and the second sensing result. To this end, the sensor controller 430 may include a first analyzer 431 and a second analyzer 432.

The first analyzer 431 may receive the first sensing result from the first sensor 410. The first analyzer 431 may recognize the touch operation of a user with reference to the first sensing result. The first analyzer 431 may also sense with reference to the first sensing result whether the electronic equipment 10 (see FIG. 1) is in an abnormal state. That is, the first analyzer 431 may analyze the touch operation of a user or abnormal signals with reference to the first sensing result. To this end, the first analyzer 431 may include a register (not shown) therein. Information on acoustic signals that vary according to the touch operation of the user may be stored in the register. Information on signals according to the abnormal state may be stored in the register.

The second analyzer 432 may receive the second sensing result from the second sensor 420. The second analyzer 432 may sense with reference to the second sensing result whether the electronic equipment 10 (see FIG. 1) is in an abnormal state. That is, the second analyzer 432 may analyze abnormal signals with reference to the second sensing result. To this end, the second analyzer 432 may include a register (not shown) therein. Information on signals according to the abnormal state may be stored in the register. The second analyzer 432 may output the sensing result to the first analyzer 431.

The first analyzer 431 may filter the acoustic signal sensed by the first sensor 410, with reference to a result of the second analyzer 432. More particularly, the first analyzer 431 may filter the first sensing result. The acoustic signal generated when the electronic equipment 10 (see FIG. 1) is in the abnormal state may be an acoustic signal that the user has not intended. Thus, the first analyzer 431 may analyze the acoustic signal that the user has not intended. The analysis result may be transmitted to the electronic equipment (see FIG. 1).

In summary, the input device 200 (see FIG. 2) according to an embodiment of the present invention may sense the acoustic signal and the abnormal signals and transmit them to the electronic equipment 10 (see FIG. 1). In another embodiment, the input device 400 (see FIG. 5) according to an embodiment of the present invention may sense, analyze, and filter the acoustic signal and the abnormal signals, and transmit them to the electronic equipment 10 (see FIG. 1).

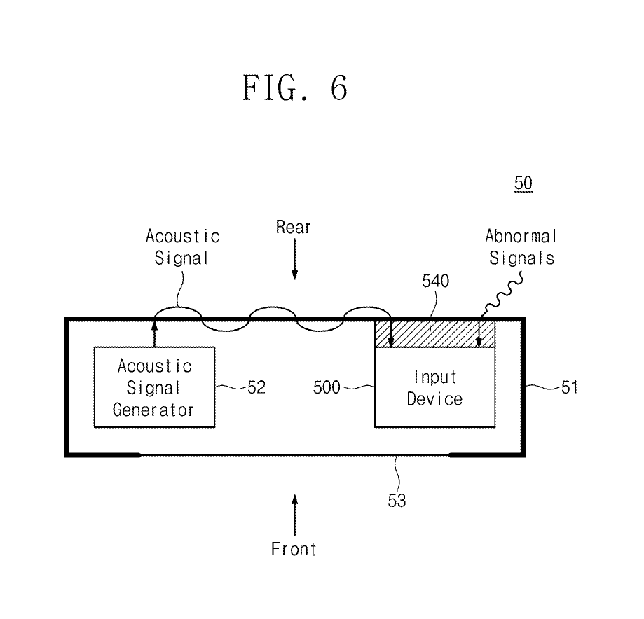

FIG. 6 is a diagram that illustrates electronic equipment to which an input device according to an embodiment of the inventive concept is applied. Referring to FIG. 6, electronic equipment 50 may include a housing 51, an acoustic signal generator 52, a display 53, and an input device 500. The housing 51, the acoustic signal generator 52, the display 53, and the input device 500 are substantially the same as those in FIG. 1.

Referring to FIG. 6, the input device 500 may further include an insulator 540 unlike the input device 100 in FIG. 1. The input device 500 may be attached to the housing 51 through the insulator 540. Thus, the insulator 540 may be disposed in the input device 500 in consideration of attachment to the housing 51.

The insulator 540 may include a medium that increases the transfer efficiency of the acoustic signal or abnormal signal. The first sensor 410 and the second sensor 420 that are shown in FIG. 5 may also be disposed inside the insulator 540, though not shown. In this case, the first sensor 410 (see FIG. 5) and the second sensor 420 (see FIG. 5) may be protected by the insulator 540.

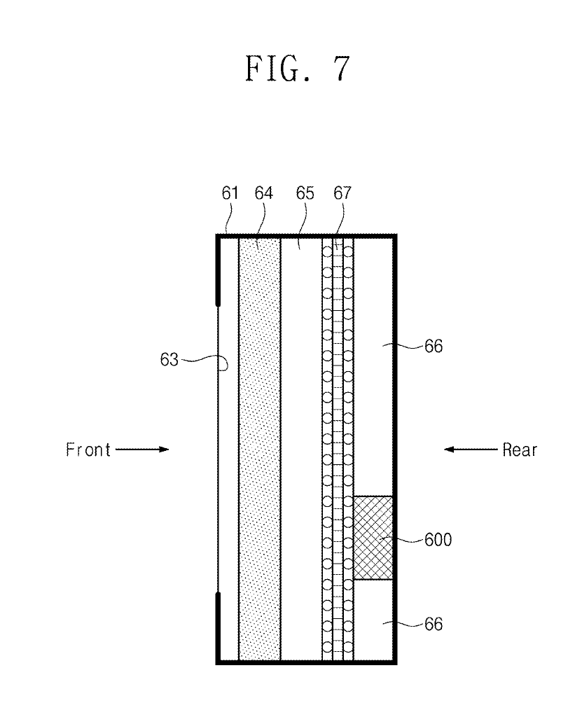

FIG. 7 is a diagram that illustrates electronic equipment to which an input device according to an embodiment of the inventive concept is applied. Referring to FIG. 7, electronic equipment 60 may include a housing 61, a plastic cover 63, a display 64, a first region 65, a second region 66, and a printed circuit board (PCB) 67, and an input device 600. The housing 61, the display 64, and the input device 600 are substantially the same as those in FIG. 1.

The plastic cover 63 may be disposed together with a portion of the housing 61 at the front surface of the electronic equipment 60. The plastic cover 63 may include a transparent material. The plastic cover 63 may protect the display 64 from an external impact.

The components (not shown) of the electronic equipment 60 may be disposed in the first region 65 and the region 66. For example, a processor, a storage module, a network module, a memory module, an antenna module, battery, etc. may be disposed in the first region 65 or the second region 66.

The components of the electronic equipment 60 may be attached to the PCB 67 by using packages having various forms. For example, packages may be used such as package on package (Pop), chip scale package (CSP), plastic dual in line package (PDIP), ceramic dual in line package (CERDIP), thin quad flat package (TQFP), shrink small outline package (SSOP), thin small outline package (TSOP), wafer-level fabricated package (WFP), and wafer-level processed stack package (WSP).

The first region 65 may mean a space between the PCB 67 and the display 64. The second region 66 may mean a space between the PCB 67 and the rear housing 61. Components that are disposed in the first region 65 and the second region 66 may be connected to the PCB 67 through a solder ball or bump.

The input device 600 according to an embodiment of the inventive concept may be disposed in the second region. More particularly, the input device 600 may be disposed between the PCB 67 and the rear housing 61. The input device 600 may also be disposed to be attached to the side surface of the electronic equipment 60.

FIG. 8 is a block diagram that illustrates a computer system to which an input device according to an embodiment of the inventive concept is applied. Referring to FIG. 8, a computer system 1000 may include a processor 1100, a user interface 1200, a display module 1300, a storage module 1400, a network module 1500, and a memory module 1600.

The processor 1100 may operate the components included in the computer system 1000, and an operating system (OS). As an example, the processor 1100 may include controllers, interfaces, a graphic engine, etc. that control the components included in the computer system 1000. The processor 1100 may be provided as a SoC.

The user interface 1200 may include interfaces that input data or a command to the processor 1100 or output data to external devices. As an example, the user interface may include user interfaces, such as a keyboard, keypad, button, touch panel, touch screen, touch pad, touch ball, camera, microphone, gyroscope sensor, vibration sensor, and piezoelectric element. The input device according to an embodiment of the inventive concept may be included in the user interface 1200.

The display module 1300 may display an image. The display module 1300 may receive display data from a display driving circuit (not shown). Here, the display driving circuit may drive the display module 1300. The display driving circuit may process the display data transmitted from the processor 1100, and transmit the processed display data to the display module 1300. The display driving circuit may be implemented in an integrated circuit. The display driving circuit may also be implemented in the processor 1100 or separately outside.

The display module 1300 may include an organic light emitting display panel, a liquid crystal display panel, a plasma display panel, an electrophoretic display panel, an electrowetting display panel, or the like.

The storage module 1400 may store data. For example, the storage module 1400 may store data received from the processor 1100. Alternatively, the storage module 1400 may transfer the data stored in the storage module 1400 to the processor 1100. As an example, the storage module 1400 may be implemented in a non-volatile semiconductor memory element, such as an erasable programmable read-only memory (EPROM), NAND flash memory, NOR flash memory, phase-change random access memory (PRAM), resistive random access memory (ReRAM), ferroelectric random access memory (FeRAM) or the like.

The network module 1500 may perform communication with external devices. As an example, the network module 1500 may support wireless communication, such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless LAN (WLAN), ultra wide band (UWB), Bluetooth, wireless display (WI-DI) or the like.

The memory module 1600 may operate as the main memory, operating memory, buffer memory or cache memory of the computer system 1000. The memory module 1600 may include a volatile memory, such as a DRAM or static random access memory (SRAM), or a non-volatile memory, such as a PRAM, ReRAM or FeRAM.

A system bus 170 may electrically connect the processor 1100, the user interface 1200, the display module 1300, the storage module 1400, the network module 1500, and the memory module 1600 one another.

The input device according to an embodiment of the inventive concept may sense the acoustic signal and a signal different therefrom. The input device according to an embodiment of the inventive concept may sense the acoustic signal to recognize the touch operation of a user. The input device according to an embodiment of the inventive concept may sense a signal different from the acoustic signal to sense whether the electronic equipment is in an abnormal state.

The above-described details are particular examples for practicing the inventive concept. The inventive concept would include not only the above-described embodiments but also embodiments that may be simply changed in design or easily changed. Also, the inventive concept would also include techniques that may be practiced through an easy variation in the future by the using of the above-described embodiments.

What is claimed is:

1. An input device of electronic equipment comprising:
a first sensor configured to receive a first acoustic signal generated by an acoustic signal generator;
a second sensor configured to receive an abnormal signal different from the first acoustic signal; and
a sensor controller configured to receive a first sensing result from the first sensor and a second sensing result from the second sensor and output the sensing results to the electronic equipment,
wherein the first acoustic signal is received by the first sensor through a housing that covers at least a portion of the electronic equipment.

2. The input device of claim 1, wherein the input device is attached to a rear or side surface of the electronic equipment.

3. The input device of claim 1, wherein the second sensor is any one of a pressure sensor, a proximity sensor, a gyro sensor, an acceleration sensor, a magnetic sensor, a temperature sensor, or a terrestrial magnetism sensor.

4. The input device of claim 1, wherein the first sensor further receives the abnormal signal.

5. The input device of claim 1, wherein the first acoustic signal varies by a user's touch on the electronic equipment, and the first sensor further receives a second acoustic signal that is a variation to the first acoustic signal.

6. The input device of claim 5, wherein the sensor controller comprises:
a first analyzer configured to analyze the user's touch on the electronic equipment with reference to the first sensing result; and
a second analyzer configured to analyze abnormal signals with reference to the second sensing result,
wherein the sensor controller outputs results of the first analyzer and the second analyzer to the electronic equipment.

7. The input device of claim 6, wherein the first analyzer further analyze the abnormal signals with reference to the first sensing result.

8. The input device of claim 7, wherein the first analyzer filters the first acoustic signal or the second acoustic signal with reference to the result of the second analyzer.

9. The input device of claim 2, further comprising an insulator that is attached to the housing.

10. The input device of claim 8, wherein the insulator protects the first sensor, the second sensor, or the sensor controller.

11. The input device of claim 9, wherein the insulator comprises a medium that increases transfer efficiency of the first acoustic signal or the abnormal signal.
